(19) United States
(12) Patent Application Publication
(10) Pub. No.: US 2009/0128467 A1
(43) Pub. Date: May 21, 2009

(54) Liquid crystal display with pixel region having nine sub-pixels

(75) Inventor: Ying Tai Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/986,393

(22) Filed: Nov. 21, 2007

(51) Int. Cl. G09G 3/36

(52) U.S. Cl. 345/87

(57) ABSTRACT

An exemplary liquid crystal display (20) includes a plurality of pixel regions arranged in a matrix manner. Each pixel region includes two first red sub-pixels, two first green sub-pixels, two first blue sub-pixels, a second red sub-pixel, a second green sub-pixel, and a second blue sub-pixel. In each pixel region, the nine sub-pixels are arranged in two rows, the two first red sub-pixels, the two first green sub-pixels, and the two first blue sub-pixels are arranged in a row, and the second red sub-pixel, the second green sub-pixel, and the second blue sub-pixel are arranged in the other row. Each second sub-pixel corresponds to two first sub-pixels of which only one has the same color with the corresponding second sub-pixel. Each two adjacent first sub-pixels have different colors.

### FIELD OF THE INVENTION

The present invention relates to liquid crystal displays (LCDs), and more particularly to an LCD with a plurality of pixel regions, wherein each of the pixel regions includes nine sub-pixels.

### GENERAL BACKGROUND

A typical LCD includes a plurality of pixels, and each pixel includes a red sub-pixel, a green sub-pixel, and a blue sub-pixel corresponding to three primary colors—red, green, and blue. Each sub-pixel is driven by a respective scan line and a respective data line of the LCD, for controlling a brightness of the sub-pixel. A full-color display mode of the LCD can be achieved by mixing the three primary colors of the sub-pixels according to predetermined proportions.

The sub-pixels of the LCD can be arranged in variety of patterns, for example in a stripe pattern or in a mosaic pattern. In FIG. 8, the sub-pixels are arranged in a stripe pattern. Colors of the sub-pixels in each row are arranged in an order of red, green, and blue, and colors of the sub-pixels in each column are the same. In FIG. 9, the sub-pixels are arranged in a mosaic pattern. Colors of the sub-pixels in each row are arranged in an order of red, green, and blue, and colors of the sub-pixels in each column are arranged in an order of red, blue and green.

According to the stripe pattern, the sub-pixels in each column have the same color, such that good display quality is obtained when the LCD with the stripe pattern is used to display monochromatic straight lines. However, the display quality is diminished when the LCD with the stripe pattern is used to display monochromatic sloping lines. As shown in FIG. 10, only some of the red sub-pixels along each diagonal line are in bright states, and other sub-pixels along each diagonal line are in dark states. The red sub-pixels in bright states are not arranged along a single sloping line, and instead form a kind of saw-tooth pattern. This irregularity in the red sloping line may be perceived by the human eye.

According to the mosaic pattern, the sub-pixels along each diagonal line have the same color, such that good display quality is obtained when the LCD with the mosaic pattern is used to display monochromatic sloping lines. However, the display quality is diminished when the LCD with the mosaic pattern is used to display monochromatic horizontal or vertical lines. As shown in FIG. 11, only some of the red sub-pixels along each column are in bright states, and other sub-pixels along each column are in dark states. The red sub-pixels in bright states are not arranged in a single vertical line, and instead form a kind of saw-tooth pattern. This irregularity in the red vertical line may be perceived by the human eye.

It is desired to provide an LCD which overcomes the above-described deficiencies.

### SUMMARY

In one aspect, a liquid crystal display includes a plurality of pixel regions arranged in a matrix. Each pixel region includes two first red sub-pixels, two first green sub-pixels, two first blue sub-pixels, a second red sub-pixel, a second green sub-pixel, and a second blue sub-pixel. In each pixel region, the nine sub-pixels are arranged in two rows, the two first red sub-pixels, the two first green sub-pixels, and the two first blue sub-pixels are arranged in a row, and the second red sub-pixel, the second green sub-pixel, and the second blue sub-pixel are arranged in the other row. Each two adjacent first sub-pixels have different colors, and each two adjacent second sub-pixels have different colors. Each second sub-pixel corresponds to two first sub-pixels. For each second sub-pixel of a particular color, one of the two corresponding first sub-pixels has the same color, and the other of the two corresponding first sub-pixels has a different color.

In another aspect, a liquid crystal display includes a plurality of pixel regions arranged in a matrix. Each pixel region includes two first red sub-pixels, two first green sub-pixels, two first blue sub-pixels, a second red sub-pixel, a second green sub-pixel, and a second blue sub-pixel. In each pixel region, the nine sub-pixels are arranged in two rows, the two first red sub-pixels, the two first green sub-pixels, and the two first blue sub-pixels are arranged in one of the rows, and the second red sub-pixel, the second green sub-pixel, and the second blue sub-pixel are arranged in the other row. In each column defined by the first sub-pixels of all the pixel regions, the first sub-pixels have the same color. Each second sub-pixel spans across two adjacent columns and has the same color as the first sub-pixels in one of the two columns. Along each of sloping lines defined by second sub-pixels in consecutive rows of the second sub-pixels having the same color. A first sub-pixel in a row of the first sub-pixels between each two adjacent second sub-pixels has the same color as the second sub-pixels.

In still another aspect, a color filter substrate includes a plurality of pixel regions arranged in a matrix. Each pixel region includes at least six first color filter units and at least three second color filter units. In each pixel region, at least two first color filter units correspond to one second color filter unit, and one of the at least two first color filter units has the same color as that of the corresponding second color filter unit.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of an LCD according to a first embodiment of the present invention, the LCD including a thin film transistor (TFT) substrate and a color filter substrate.

FIG. 2 is a top plan view of part of the TFT substrate of the LCD of FIG. 1.

FIG. 3 is a top plan view of an arrangement of color filter units of the color filter substrate of the LCD of FIG. 1, such view corresponding to the part of the TFT substrate shown in FIG. 2.

FIG. 4 is a diagram illustrating an operation principle of displaying a red vertical line on the LCD of FIG. 1.

FIG. 5 is a diagram illustrating an operation principle of displaying a red sloping line on the LCD of FIG. 1.

FIG. 6 is a top plan view of part of a TFT substrate of an LCD according to a second embodiment of the present invention.

FIG. 7 is a top plan view of an arrangement of color filter units of a color filter substrate of the LCD according to the second embodiment, such view corresponding to the part of the TFT substrate shown in FIG. 6.

FIG. 8 is a plan view of sub-pixels arranged in a stripe pattern in a conventional LCD.

FIG. 9 is a plan view of sub-pixels arranged in a mosaic pattern in another conventional LCD.

FIG. 10 is a schematic diagram illustrating an operation principle of displaying a red sloping line on the LCD of FIG. 8.

FIG. 11 is a schematic diagram illustrating an operation principle of displaying a red vertical line on the LCD of FIG. 9.

### DETAILED DESCRIPTION OF PREFERRED EMBODIMENTS

Reference will now be made to the drawings to describe various embodiments of the present invention in detail.

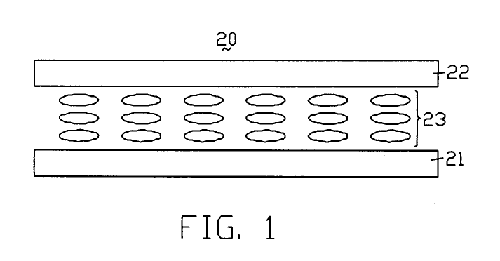

FIG. 1 is a side cross-sectional view of an LCD of according to a first embodiment of the present invention. The LCD 20 includes a thin film transistor substrate (TFT substrate) 21, a color filter substrate 22, and a liquid crystal layer 23 interposed therebetween. The liquid crystal layer 23 includes a multiplicity of liquid crystal molecules.

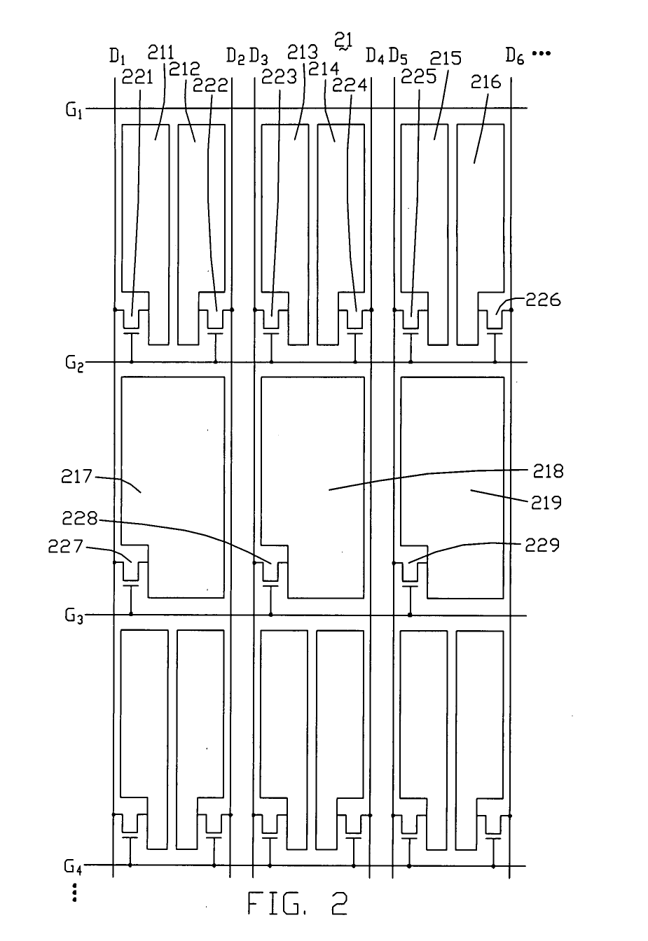

FIG. 2 is a top plan view of part of the TFT substrate 21 of the LCD 20 of FIG. 1. The TFT substrate 21 includes a plurality of scan lines G1, G2, G3, G4 . . . , a plurality of data lines D1, D2, D3, D4, D5, D6 . . . , a plurality of pixel electrodes, and a plurality of TFTs. Each scan line provides scan signals to corresponding TFTs, and each data line provides data signals to corresponding TFTs. For simplicity, the following description is couched in terms that relate to a small portion or unit of the TFT substrate 21, such unit forming one of a repetitive array of such units across an expanse of the TFT substrate 21.

An area enclosed by the scan lines G1 and G2 and the data lines D1 and D2 includes a first pixel electrode 211, a second pixel electrode 212, a first TFT 221, and a second TFT 222. The first TFT 221 is positioned near a crossing of the scan line G2 and the data line D1. A gate electrode of the first TFT 221 is connected to the scan line G2, and a source electrode of the first TFT 221 is connected to the data line D1. Further, a drain electrode of the first TFT 221 is connected to the first pixel electrode 211. The second TFT 222 is positioned near a crossing of the scan line G2 and the data line D2. A gate electrode of the second TFT 222 is connected to the scan line G2, and a source electrode of the second TFT 222 is connected to the data line D2. Further, a drain electrode of the second TFT 222 is connected to the second pixel electrode 212.

An area enclosed by the scan lines G1 and G2 and the data lines D3 and D4 includes a third pixel electrode 213, a fourth pixel electrode 214, a third TFT 223, and a fourth TFT 224. The third TFT 223 is positioned near a crossing of the scan line G2 and the data line D3. A gate electrode of the third TFT 223 is connected to the scan line G2, and a source electrode of the third TFT 223 is connected to the data line D3. Further, a drain electrode of the third TFT 223 is connected to the third pixel electrode 213. The fourth TFT 224 is positioned near a crossing of the scan line G2 and the data line D4. A gate electrode of the fourth TFT 224 is connected to the scan line G2, and a source electrode of the fourth TFT 224 is connected to the data line D4. Further, a drain electrode of the fourth TFT 224 is connected to the fourth pixel electrode 214.

An area enclosed by the scan lines G1 and G2 and the data lines D5 and D6 includes a fifth pixel electrode 215, a sixth pixel electrode 216, a fifth TFT 225, and a sixth TFT 226. The fifth TFT 225 is positioned near a crossing of the scan line G2 and the data line D5. A gate electrode of the fifth TFT 225 is connected to the scan line G2, and a source electrode of the fifth TFT 225 is connected to the data line D5. Further, a drain electrode of the fifth TFT 225 is connected to the fifth pixel electrode 215. The sixth TFT 226 is positioned near a crossing of the scan line G2 and the data line D6. A gate electrode of the sixth TFT 226 is connected to the scan line G2, and a source electrode of the sixth TFT 226 is connected to the data line D6. Further, a drain electrode of the sixth TFT 226 is connected to the sixth pixel electrode 216.

An area enclosed by the scan lines G2 and G3 and the data lines D1 and D2 includes a seventh pixel electrode 217 and a seventh TFT 227. The seventh TFT 227 is positioned near a crossing of the scan line G3 and the data line D1. A gate electrode of the seventh TFT 227 is connected to the scan line G3, and a source electrode of the seventh TFT 227 is connected to the data line D1. Further, a drain electrode of the seventh TFT 227 is connected to the seventh pixel electrode 217.

An area enclosed by the scan lines G2 and G3 and the data lines D3 and D4 includes an eighth pixel electrode 218 and an eighth TFT 228. The eighth TFT 228 is positioned near a crossing of the scan line G3 and the data line D3. A gate electrode of the eighth TFT 228 is connected to the scan line G3, and a source electrode of the eighth TFT 228 is connected to the data line D3. Further, a drain electrode of the eighth TFT 228 is connected to the eighth pixel electrode 218.

An area enclosed by the scan lines G2 and G3 and the data lines D5 and D6 includes a ninth pixel electrode 219 and a ninth TFT 229. The ninth TFT 229 is positioned near a crossing of the scan line G3 and the data line D5. A gate electrode of the ninth TFT 229 is connected to the scan line G3, and a source electrode of the ninth TFT 229 is connected to the data line D5. Further, a drain electrode of the ninth TFT 229 is connected to the ninth pixel electrode 219.

The pixel electrodes 211, 212, 213, 214, 215, 216 (211˜216) have the same area, and the pixel electrodes 217, 218, 219 (217˜219) have the same area. The area of each of the pixel electrodes 211˜216 is approximately half of the area of each of the pixel electrodes 217˜219.

Other pixel electrodes and TFTs are arranged similar to the arrangement described above.

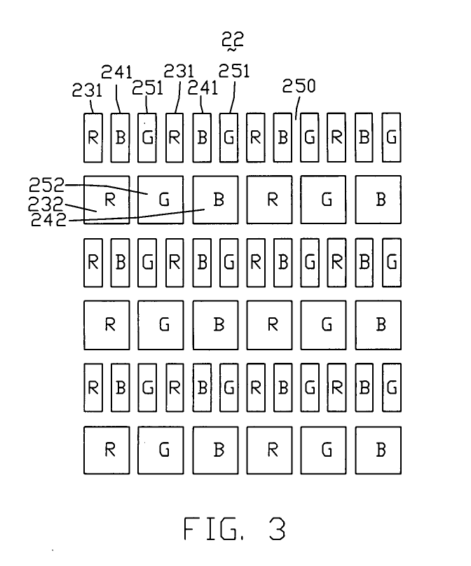

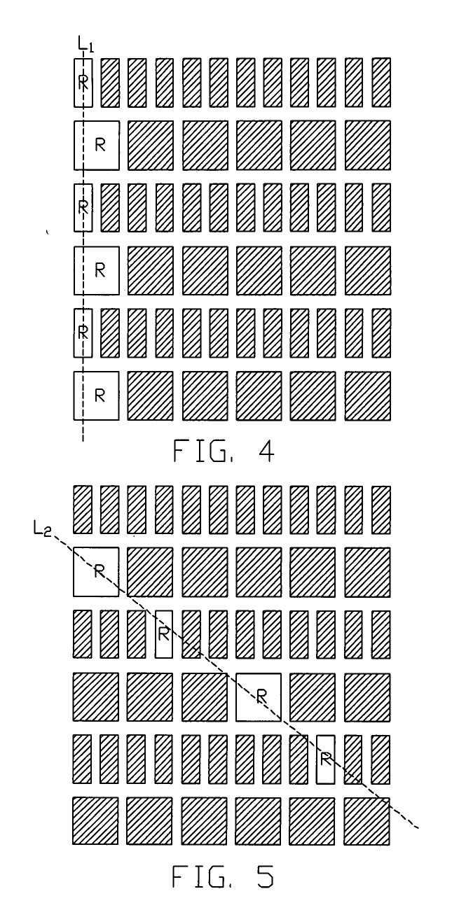

FIG. 3 is a top plan view of an arrangement of color filter units of the color filter substrate 22 of the LCD 20 of FIG. 1. The color filter substrate 22 includes rows of first color filter unit strips and rows of second color filter unit strips alternately arranged. The first color filter units include a plurality of first red color filter units 231, a plurality of first blue color filter units 241, and a plurality of first green color filter units 251. The second color filter units include a plurality of second red color filter units 232, a plurality of second green color filter units 252, and a plurality of second blue color filter units 242. The plurality of color filter units 231, 241, 251, 232, 252, 242 are separated by a black matrix 250. Colors of each first color filter unit strip are arranged in an order of red, blue, and green. Colors of each second color filter unit strip are arranged in an order of red, green, and blue. In addition, areas of the first red color filter units 231, the first green color filter units 251, and the first blue color filter units 241 are equal, and areas of the second red color filter units 232, the second green color filter units 252, and the second blue color filter units 242 are equal. The area of each first red color filter unit 231 is approximately half of the area of each second red color filter unit 232. The area of each first blue color filter unit 241 is approximately half of the area of each second blue color filter unit 242. The area of each first green color filter unit 251 is approximately half of the area of each second green color filter unit 252. Thus taking the first row of first color filter unit strips and the first row of second color filter unit strips as an example, the following configurations are provided. A first red color filter unit 231 and a first blue color filter unit 241 correspond to a second red color filter unit 232, a first green color filter unit 251 and a first red color filter unit 231 correspond to a second green color filter unit 252, and a first blue color filter unit 241 and a first green color filter unit 251 correspond to a second blue color filter unit 242.

In assembly, the TFT substrate 21 and the color filter substrate 22 are aligned and adhered together. The liquid crystal layer 23 is interposed between the TFT and color filter substrates 21, 22. The first pixel electrode 211, the first TFT 221, the first red color filter unit 231 generally opposite to the first pixel electrode 211, and liquid crystal molecules interposed between the first pixel electrode 211 and the first red color filter unit 231 cooperatively define a first red sub-pixel (not labeled). The fourth pixel electrode 214, the fourth TFT 224, the first red color filter unit 231 generally opposite to the fourth pixel electrode 214, and liquid crystal molecules interposed between the fourth pixel electrode 214 and the first red color filter unit 231 cooperatively define another first red sub-pixel (not labeled).

The second pixel electrode 212, the second TFT 222, the first blue color filter unit 241 generally opposite to the second pixel electrode 212, and liquid crystal molecules interposed between the second pixel electrode 212 and the first blue color filter unit 241 cooperatively define a first blue sub-pixel (not labeled). The fifth pixel electrode 215, the fifth TFT 225, the first blue color filter unit 241 generally opposite to the fifth pixel electrode 215, and liquid crystal molecules interposed between the fifth pixel electrode 215 and the first blue color filter unit 241 cooperatively define another first blue sub-pixel (not labeled).

The third pixel electrode 213, the third TFT 223, the first green color filter unit 251 generally opposite to the third pixel electrode 213, and liquid crystal molecules interposed between the third pixel electrode 213 and the first green color filter unit 251 cooperatively define a first green sub-pixel (not labeled). The sixth pixel electrode 216, the sixth TFT 226, the first green color filter unit 251 generally opposite to the sixth pixel electrode 216, and liquid crystal molecules interposed between the sixth pixel electrode 216 and the first green color filter unit 251 cooperatively define another first green sub-pixel (not labeled).

The seventh pixel electrode 217, the seventh TFT 227, the second red color filter unit 232 generally opposite to the seventh pixel electrode 217, and liquid crystal molecules interposed between the seventh pixel electrode 217 and the second red color filter unit 232 cooperatively define a second red sub-pixel (not labeled). The eighth pixel electrode 218, the eighth TFT 228, the second green color filter unit 252 generally opposite to the eighth pixel electrode 218, and liquid crystal molecules interposed between the eighth pixel electrode 218 and the second green color filter unit 252 cooperatively define a second green sub-pixel (not labeled). The ninth pixel electrode 219, the ninth TFT 229, the second blue color filter unit 242 generally opposite to the ninth pixel electrode 219, and liquid crystal molecules interposed between the ninth pixel electrode 219 and the second blue color filter unit 242 cooperatively define a second blue sub-pixel (not labeled).

Two first red sub-pixels, two first green sub-pixels, two first blue sub-pixels, a second red sub-pixel, a second green sub-pixel, and a second blue sub-pixel cooperatively define a pixel region (not labeled). The LCD 20 includes a plurality of pixel regions, and the pixel regions are arranged in a matrix. Each sub-pixel is driven by a corresponding scan line and a corresponding data line, for controlling a brightness of the sub-pixel. A full-color display mode of the LCD 20 is achieved by mixing the three primary colors of the sub-pixels according to predetermined proportions.

Referring to FIG. 4, this illustrates displaying of a red straight line along the dashed line L₁. Only the first red sub-pixels and the second red sub-pixels along the dashed line L₁ are in bright states, and other sub-pixels are in dark states. The first and the second red sub-pixels in bright states are arranged along a single straight line, such that good display quality can be obtained when the LCD 20 is used to display monochromatic straight lines.

Referring to FIG. 5, this illustrates displaying of a red sloping line along the dashed line L₂. Only the first and the second red sub-pixels along the dashed line L₂ are in bright states, and other sub-pixels are in dark states. The first and the second red sub-pixels in bright states are arranged along a single sloping line, such that good display quality can be obtained when the LCD 20 is used to display monochromatic sloping lines.

An arrangement pattern of the sub-pixels of the LCD 20 can be regarded as a combination of a stripe pattern and a mosaic pattern. When the LCD 20 is used to display monochromatic straight lines, the arrangement pattern of the sub-pixels in bright states can be regarded as the stripe pattern. When the LCD 20 is used to display monochromatic sloping lines, the arrangement pattern of the sub-pixels in bright states can be regarded as the mosaic pattern. The LCD 20 has the advantages of both the stripe pattern and the mosaic pattern. Thus, the display quality of the LCD 20 is enhanced.

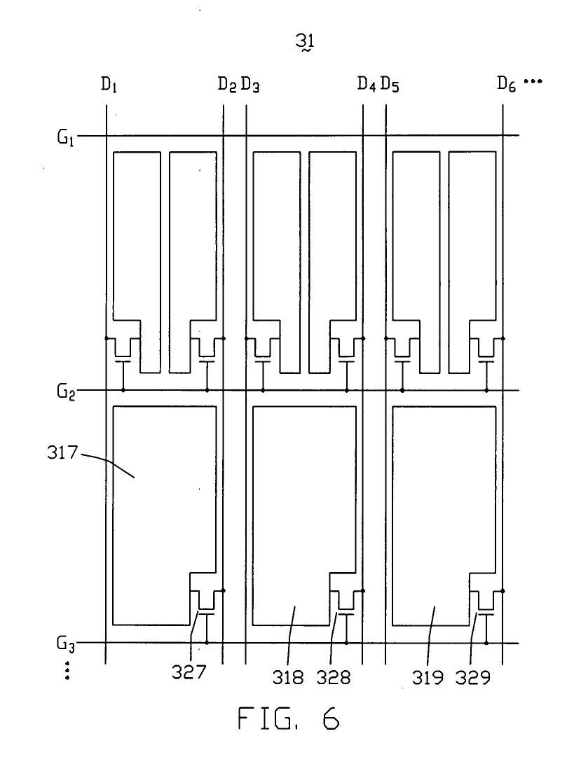

FIG. 6 is a top plan view of part of a TFT substrate 31 of an LCD (not shown) according to a second embodiment of the present invention. Characteristics of the TFT substrate 31 that are different from the TFT substrate 21 are as follows:

A seventh TFT 327 is positioned near a crossing of the scan line G3 and the data line D2. A gate electrode of the seventh TFT 327 is connected to the scan line G3, and a source electrode of the seventh TFT 327 is connected to the data line D2. Further, a drain electrode of the seventh TFT 327 is connected to the seventh pixel electrode 317.

An eighth TFT 328 is positioned near a crossing of the scan line G3 and the data line D4. A gate electrode of the eighth TFT 328 is connected to the scan line G3, and a source electrode of the eighth TFT 328 is connected to the data line D4. Further, a drain electrode of the eighth TFT 328 is connected to the eighth pixel electrode 318.

A ninth TFT 329 is positioned near a crossing of the scan line G3 and the data line D6. A gate electrode of the ninth TFT 329 is connected to the scan line G3, and a source electrode of the ninth TFT 329 is connected to the data line D6. Further, a drain electrode of the ninth TFT 329 is connected to the ninth pixel electrode 319.

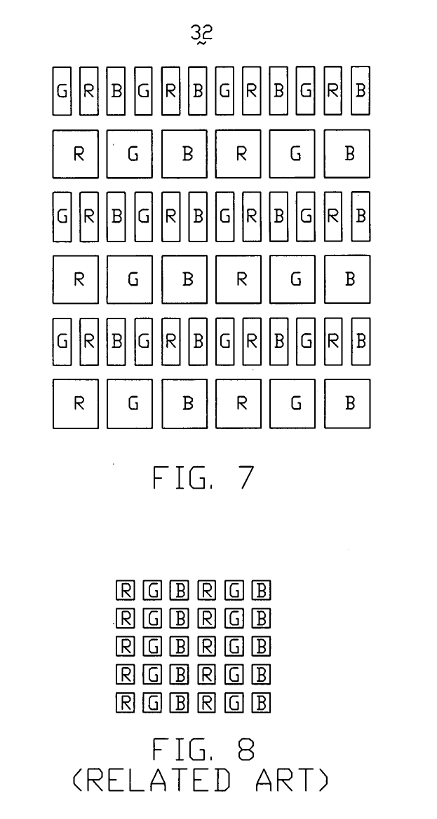

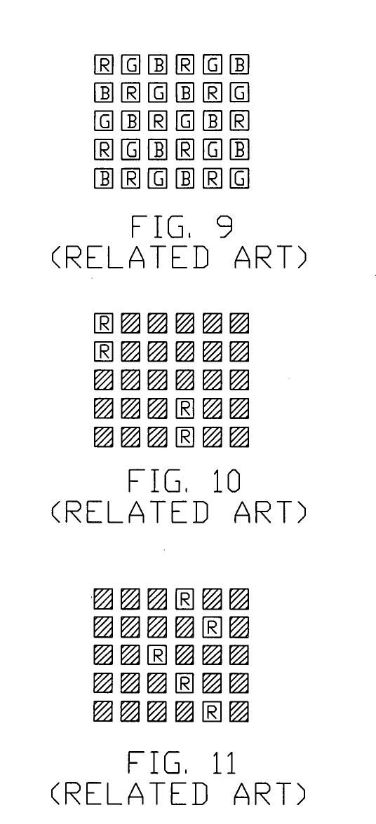

FIG. 7 is a top view of an arrangement of color filter units of a color filter substrate 32 of the LCD according to the second embodiment of the present invention. Characteristics of the color filter substrate 32 that are different from the color filter substrate 22 are as follows:

Colors of each first color filter unit strip are arranged in an order of green, red, and blue. Colors of each second color filter unit strip are arranged in an order of red, green, and blue. A first green color filter unit (not labeled) and a first red color filter unit (not labeled) correspond to a second red color filter unit (not labeled), a first blue color filter unit (not labeled) and a first green color filter unit correspond to a second green color filter unit (not labeled), and a first red color filter unit and a first blue color filter unit correspond to a second blue color filter unit (not labeled).

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of the present invention to the full extent indicated by the broad general meaning of the terms in which the appended claims are expressed.

What is claimed is:

1. A liquid crystal display, comprising:
a plurality of pixel regions arranged in a matrix, each pixel region comprising two first red sub-pixels, two first green sub-pixels, two first blue sub-pixels, a second red sub-pixel, a second green sub-pixel, and a second blue sub-pixel; wherein in each pixel region, the nine sub-pixels are arranged in two rows, with the two first red sub-pixels, the two first green sub-pixels, and the two first blue sub-pixels being arranged in one of the rows, and the second red sub-pixel, the second green sub-pixel, and the second blue sub-pixel being arranged in the other row;
each two adjacent first sub-pixels have different colors, and each two adjacent second sub-pixels have different colors;
each second sub-pixel corresponds to two first sub-pixels; and
for each second sub-pixel of a particular color, one of the two corresponding first sub-pixels has the same color, and the other of the two corresponding first sub-pixels has a different color.

2. The liquid crystal display as claimed in claim 1, wherein areas of all the first sub-pixels are equal.

3. The liquid crystal display as claimed in claim 2, wherein areas of all the second sub-pixels are equal.

4. The liquid crystal display as claimed in claim 3, wherein an area of each first sub-pixel is approximately half of an area of each second sub-pixel.

5. The liquid crystal display as claimed in claim 1, wherein in each pixel region, the second red sub-pixel corresponds to one of the first red sub-pixels and one of the first blue sub-pixels, the second green sub-pixel corresponds to one of the first green sub-pixels and the other first red sub-pixel, and the second blue sub-pixel corresponds to the other first blue sub-pixel and the other first green sub-pixel.

6. The liquid crystal display as claimed in claim 5, wherein in each pixel region, colors of the first sub-pixels are arranged in an order of red, blue, and green, and colors of the second sub-pixels are arranged in an order of red, green, and blue.

7. The liquid crystal display as claimed in claim 1, wherein in each pixel region, the second red sub-pixel corresponds to one of the first green sub-pixels and one of the first red sub-pixels, the second green sub-pixel corresponds to one of the first blue sub-pixels and the other first green sub-pixel, and the second blue sub-pixel corresponds to the other first red sub-pixel and the other first blue sub-pixel.

8. The liquid crystal display as claimed in claim 7, wherein in each pixel region, colors of the first sub-pixels are arranged in an order of green, red, and blue, and colors of the second sub-pixels are arranged in an order of red, green, and blue.

9. The liquid crystal display as claimed in claim 1, further comprising a plurality of scan lines and a plurality of data lines, wherein the first sub-pixels in the same row are supplied scan signals by one of the scan lines, the second sub-pixels in the same row are supplied scan signals by another one of the scan lines, the first sub-pixels in a same column are supplied data signals by a data line, the second sub-pixels in the same column are supplied data signals by a data line.

10. The liquid crystal display as claimed in claim 9, wherein the first red sub-pixel comprises a pixel electrode, a thin film transistor, a red color filter, the red color filter corresponds to the pixel electrode, a gate electrode of the thin film transistor is connected to a scan line, a source electrode of the thin film transistor is connected to a data line, a drain electrode of the thin film transistor is connected to the pixel electrode.

11. The liquid crystal display as claimed in claim 9, wherein the first green sub-pixel comprises a pixel electrode, a thin film transistor, a green color filter, the green color filter corresponds to the pixel electrode, a gate electrode of the thin film transistor is connected to a scan line, a source electrode of the thin film transistor is connected to a data line, a drain electrode of the thin film transistor is connected to the pixel electrode.

12. The liquid crystal display as claimed in claim 9, wherein the first blue sub-pixel comprises a pixel electrode, a thin film transistor, a blue color filter, the blue color filter corresponds to the pixel electrode, a gate electrode of the thin film transistor is connected to a scan line, a source electrode of the thin film transistor is connected to a data line, a drain electrode of the thin film transistor is connected to the pixel electrode.

13. The liquid crystal display as claimed in claim 9, wherein the second red sub-pixel comprises a pixel electrode, a thin film transistor, a red color filter, the red color filter corresponds to the pixel electrode, a gate electrode of the thin film transistor is connected to a scan line, a source electrode of the thin film transistor is connected to a data line, a drain electrode of the thin film transistor is connected to the pixel electrode.

14. The liquid crystal display as claimed in claim 9, wherein the second green sub-pixel comprises a pixel electrode, a thin film transistor, a green color filter, the green color filter corresponds to the pixel electrode, a gate electrode of the thin film transistor is connected to a scan line, a source electrode of the thin film transistor is connected to a data line, a drain electrode of the thin film transistor is connected to the pixel electrode.

15. The liquid crystal display as claimed in claim 9, wherein the second blue sub-pixel comprises a pixel electrode, a thin film transistor, a blue color filter, the blue color filter corresponds to the pixel electrode, a gate electrode of the thin film transistor is connected to a scan line, a source electrode of the thin film transistor is connected to a data line, a drain electrode of the thin film transistor is connected to the pixel electrode.

16. A liquid crystal display, comprising:
a plurality of pixel regions arranged in a matrix, each pixel region comprising two first red sub-pixels, two first green sub-pixels, two first blue sub-pixels, a second red sub-pixel, a second green sub-pixel, and a second blue sub-pixel; wherein in each pixel region, the nine sub-pixels are arranged in two rows, the two first red sub-pixels, the two first green sub-pixels, and the two first blue sub-pixels are arranged in one of the rows, the second red sub-pixel, the second green sub-pixel, and the second blue sub-pixel are arranged in the other row;
in each of columns defined by the first sub-pixels of all the pixel regions, the first sub-pixels have the same color;
each second sub-pixel spans across two adjacent columns and has the same color as the first sub-pixels in one of the two columns;
along each of sloping lines defined by second sub-pixels in consecutive rows of the second sub-pixels having the same color, a first sub-pixel in a row of the first sub-pixels between each two adjacent second sub-pixels has the same color as the second sub-pixels.

17. A color filter substrate, comprising:
a plurality of pixel regions arranged in a matrix, each pixel region comprising at least six first color filter units and at least three second color filter units; wherein in each pixel region, at least two first color filter units correspond to one second color filter unit, and one of the at least two first color filter units has the same color as that of the corresponding second color filter unit.

18. The color filter substrate as claimed in claim 17, wherein each pixel region comprises two first red color filter units, two first green color filter units, two first blue color filter units, a second red color filter units, a second green color filter units, and a second blue color filter units, the second red color filter unit corresponds to a first red color filter unit and a first blue color filter unit, the second green color filter unit corresponds to a first green color filter unit and the other first red color filter unit, the second blue color filter unit corresponds to the other first blue color filter unit and the other first green color filter unit.

19. The color filter substrate as claimed in claim 17, wherein each pixel region comprises two first red color filter units, two first green color filter units, two first blue color filter units, a second red color filter units, a second green color filter units, and a second blue color filter units, the second red color filter unit corresponds to a first green color filter unit and a first red color filter unit, the second green color filter unit corresponds to a first blue color filter unit and the other first green color filter unit, the second blue color filter unit corresponds to the other first red color filter unit and the other first blue color filter unit.
